(19) United States
(12) Patent Application Publication
(10) Pub. No.: US 2010/0316877 A1
(43) Pub. Date: Dec. 16, 2010

(54) METHOD FOR PREPARING POLYIMIDE AND POLYIMIDE PREPARED USING THE SAME

(75) Inventors: Heon-Sik Song, Daejeon Metropolitan City (KR); Kwang-Joo Lee, Daejeon Metropolitan City (KR); Joo-Eun Ko, Daejeon Metropolitan City (KR)

Correspondence Address: MCKENNA LONG & ALDRIDGE LLP, 1900 K STREET, NW, WASHINGTON, DC, 20006, US

(73) Assignee: LG CHEM. LTD., SEOUL (KR)

(21) Appl. No.: 12/449,454

(22) PCT Filed: Jan. 18, 2008
(86) PCT No.: PCT/KR2008/000334

§ 371 Date: Aug. 7, 2009

(30) Foreign Application Priority Data
Feb. 9, 2007 (KR) 2007-0013857

(51) Int. Cl. B32B 15/08; C08G 73/10

(52) U.S. Cl. 428/458; 528/335; 528/336

(57) ABSTRACT

The present invention relates to a method for preparing polyimide having excellent heat resistance and processibility and, more particularly, to a method of preparing polyimide which has desirable mechanical strength during curing at low temperatures and excellent processibility to be used as an insulating film of a metal laminate plate or a coverlay film for print substrates or hard disks, and polyimide prepared using the same.

### TECHNICAL FIELD

The present invention relates to a method for preparing polyimide having excellent heat resistance and processibility and, more particularly, to a method for preparing polyimide which has desirable mechanical strength during curing at low temperatures and excellent processibility to be used as an insulating film of a metal laminate plate or a coverlay film for print substrates or hard disks, and polyimide prepared using the same.

This application claims priority from Korean Patent Application No. 10-2007-0013857 filed on Feb. 9, 2007 in the Korean Intellectual Property Office, the disclosure of which is incorporated herein by reference in its entirety.

### BACKGROUND ART

A polyimide resin is used to form a film type (thin film type) flexible polyimide metal laminate plate to which a polyimide film and a metal thin plate or metal clad are fixed, and a coverlay film for flexible print substrates or hard disks. Examples of the flexible polyimide metal laminate plate include a flexible copper clad laminate plate containing copper clads having a thickness of 5 to 20 μm and polyimide resin layers having a thickness of 2 to 100 μm. The flexible polyimide metal laminate plate is processed so that a predetermined circuit pattern is formed on a metal thin plate using processes such as exposure, development, and etching. Thus, the flexible polyimide metal laminate plate is used as tape-automated bonding (TAB) products that are capable of being divided into IC (Integrated Circuit) packages in which lead wires are formed on the metal thin plate and flexible connection cables in electronic devices, digital cameras, mobile phones, and the like.

Examples of the flexible polyimide metal laminate plate include a three-layered metal laminate plate which is produced using a laminating process for attaching a polyimide resin film and a metal thin plate by means of an adhesive, and a two-layered metal laminate plate in which polyimide is attached to a side of a metal thin plate while an adhesive is not used. As compared to the three-layered metal laminate plate, the two-layered metal laminate plate is better in views of heat resistance, fine pitches, lightness and slimness, and multilayering. Thus, the demand for two-layered metal laminate plates is rapidly growing. Examples of production processes of the two-layered flexible polyimide metal laminate plate may include a casting process for applying a polyamic acid solution that is a polyimide resin precursor and then heating the polyamic acid solution to perform imidization.

In respects to production of the flexible polyimide metal laminate plate using the laminating process and the casting process, the polyamic acid solution that is a precursor solution of the polyimide resin is cured at a temperature of 250° C. or more to perform imidization, thus producing the flexible polyimide resin. However, the production for polyimide resin is problematic in that heating devices are enlarged due to heat treatment at high temperatures when it is required to improve production efficiency.

Furthermore, the known method for preparing the polyimide resin is problematic in that since imidization is performed in a solution state and precipitation is performed in a solvent such as methanol after the imidization to obtain solids, the solids to be processed need to be dissolved in the solvent.

### DISCLOSURE OF INVENTION

### Technical Problem

The present inventors found that polyimide having excellent heat resistance and processibility is prepared at low temperatures when a catalyst is added to a polyamic acid solution during a preparation process of polyimide, thereby accomplishing the present invention.

Accordingly, it is an object of the present invention to provide a method for preparing polyimide which is imidized at low temperatures using a catalyst.

It is another object of the present invention to provide polyimide prepared using the method.

### Technical Solution

In order to accomplish the above objects, the present invention provides a method for preparing polyimide, which includes a) preparing a polyamic acid solution using dianhydridea solvent, b) adding a catalyst to the polyamic acid solution, c) applying the polyamic acid solution containing the catalyst, and d) drying and curing the applied polyamic acid solution to perform imidization.

Furthermore, the present invention provides polyimide prepared using the preparation method of polyimide.

Furthermore, the present invention provides a metal laminate plate including polyimide.

Furthermore, the present invention provides a coverlay of a metal laminate plate including polyimide.

### Advantageous Effects

In a method for preparing polyimide according to the present invention, since a polyamic acid solution is applied and then imidized, it is unnecessary to additionally dissolve solids in a solvent in order to prepare polyimide. A process for preparing polyimide may be simplified. In addition, polyimide which is prepared according to the method of the present invention has desirable mechanical strength during curing at low temperatures and excellent processibility. Thus, preparation efficiency is improved. Furthermore, polyimide has excellent heat resistance and processibility to be easily used as an insulating film of a metal laminate plate or a coverlay film for print substrates or hard disks.

### BEST MODE FOR CARRYING OUT THE INVENTION

The present invention provides a method for preparing polyimide, which includes the steps of a) preparing a polyamic acid solution using dianhydride, diamine, and a solvent, b) adding a catalyst to the polyamic acid solution, c) applying the polyamic acid solution containing the catalyst, and d) drying and curing the applied polyamic acid solution to perform imidization.

In the present invention, in step a, the polyamic acid solution is prepared using dianhydride, diamine, and the solvent. The polyamic acid solution may be prepared using dianhydride represented by Formula 1 and diamine represented by Formula 2 according to a method known in the related art.

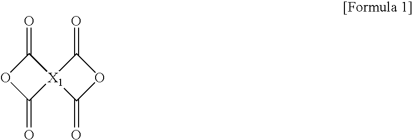

wherein X₁ is one or more selected from the group consisting of

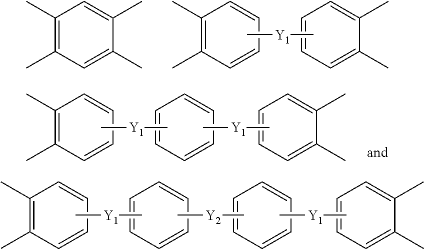

Y₁ and Y₂ are each independently or simultaneously selected from the group consisting of a direct bond, —O—, —CO—, —S—, —SO₂—, —C(CH₃)₂—, —CONH, —(CH₂)n₁-, —O(CH₂)n₂O—, —COO(CH₂)n₃OCO—, and halogen, and

n₁, n₂, and n₃ are each independently an integer in the range of 1 to 5.

H₂N—X₂—NH₂ [Formula 2]

wherein, X₂ is one or more selected from the group consisting of

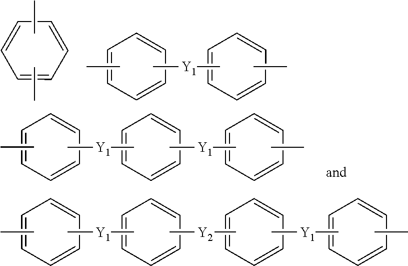

Y₁ and Y₂ are each independently or simultaneously selected from the group consisting of a direct bond, —O—, —CO—, —S—, —SO₂—, —C(CH₃)₂—, —CONH, —(CH₂)n₁-, —O(CH₂)n₂O—, —COO(CH₂)n₃OCO—, and halogen, and

n₁, n₂, and n₃ are each independently an integer in the range of 1 to 5.

Specifically, in the method for preparing the polyamic acid solution, one or more of the diamine compounds represented by Formula 2 are dissolved in the solvent, and one or more of dianhydride compounds represented by Formula 1 are added to the solution to react with the solution. It is preferable to react diamine and dianhydride at 0 to 5° C. for 24 hours. In this connection, it is preferable to mix dianhydride and diamine with each other at a molar ratio of 1:0.9 to 1:1.1. If the molar ratio of diamine to dianhydride is less than 0.9 or more than 1.1, the molecular weight is reduced, it is difficult to prepare polyimide having excellent mechanical properties, and it is difficult to perform the application and other processes due to reduced viscosity.

Specifically, dianhydride may be one or more selected from the group consisting of PMDA (pyromellitic dianhydride), BPDA (3,3′,4,4′-biphenyltetracarboxylic dianhydride), BTDA (3,3′,4,4′-benzophenonetetracarboxylic dianhydride), ODPA (4,4′-oxydiphthalic anhydride), BPADA (4,4′-(4,4′-isopropylbiphenoxy)biphthalic anhydride), 6FDA (2,2′-bis-(3,4-dicarboxylphenyl)hexafluoropropane dianhydride), and TMEG (ethyleneglycolbis(anhydro-trimellitate)), but is not limited thereto.

Diamine may be one or more selected from the group consisting of p-PDA (p-phenylenediamine), m-PDA (m-phenylenediamine), 4,4′-ODA (4,4′-oxydianiline), 3,4′-ODA (oxydianiline), BAPP (2,2-bis(4-[4-aminophenoxy]-phenyl)propane), TPE-R (1,3-bis(4-aminophenoxy)benzene), and m-BAPS (2,2-bis(4-[3-aminophenoxy]phenyl)sulfone), but is not limited thereto.

A typical organic solvent may be used. Specifically, the solvent may be one or more selected frau the group consisting of N-methylpyrrolidinone (NMP), N,N-dimethylacetamide (DMAc), tetrahydrofuran (THF), N,N-dimethylformamide (DMF), dimethylsulfoxide (DMSO), cyclohexane, acetonitrile, and a mixture thereof, but is not limited thereto.

It is preferable that the content of polyamic acid of the polyamic acid solution be 10 to 30 wt % based on the total weight of the polyamic acid solution. If the content of polyamic acid is less than 10 wt %, the amount of solvent used is unnecessarily increased. If the content of polyamic acid is more than 30 wt %, it is difficult to perform uniform application due to very high viscosity of the solution.

According to the present invention, in addition to the above-mentioned compounds, dianhydride and diamine may be added in a small amount if necessary, and one or more selected from the group consisting of a defoaming agent, a gel inhibiting agent, and an additional curing promoting agent may be added in order to easily perform the application or curing or improve other physical properties.

In the present invention, during step b, the catalyst is added to the polyamic acid solution. In this connection, it is preferable that the catalyst be added in a content of 0.1 to 20 wt % based on the total weight of the polyamic acid solid.

If the content of the catalyst is less than 0.1 wt %, the decrease effect of a curing temperature is reduced during the curing process. If the content of the catalyst is more than 20 wt %, the amount of the catalyst is relatively increased in respects to the total weight, which affects physical properties of the film. Furthermore, even though the content is more than the above-mentioned limit, a better effect cannot be obtained.

Examples of the catalyst may include one or more compounds selected from the group consisting of tertiary amine, secondary amine, azole, phosphine, and malononitrile. Specific examples of the catalyst include 1,4-diazabicyclo[2,2,2]octane, 1,8-diazabicyclo[5,4,0]-undecene, 2,6-dimethylpiperidine, triethylamine, N,N,N,N′-tetramethylethylenediamine, triphenylphosphine, 4-dimethylaminopyridine, tripropylamine, tributylamine, trioctylamine, N,N-dimethylbenzylamine, 1,2,4-triazole, and triisobutylamine, but are not limited thereto.

In the present invention, during step c, the polyamic acid solution which contains the catalyst is applied on a substrate on which a metal belt, a transparent conductive film, and a metal electrode are patterned. Examples of application methods of the polyamic acid solution may include a die coater method, a comma coater method, a reverse comma coater method, and a gravure coater method. In addition to them, a typical application method which is known in the related art may be used.

In the present invention, during step d, the applied polyamic acid solution is dried and cured to perform imidization. It is preferable to perform the drying at 50 to 140° C. for 2 to 60 min and the curing at 150 to 230° C. for 10 to 120 min.

In the preparation method according to the present invention, the polyamic acid solution to which the catalyst is added is used to perform the imidization at a low temperature of less than 250° C.

Furthermore, the present invention provides polyimide prepared using the preparation method.

The polyimide polymer which is prepared using the polyamic acid solution may be represented by the following Formula 3.

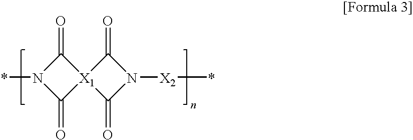

wherein X₁ and X₂ are the same as those of Formulae 1 and 2.

Furthermore, the present invention provides a metal laminate plate including polyimide.

The metal laminate plate may have a two-layered structure or three-layered structure. For example, the two-layered flexible polyimide metal laminate plate may be manufactured using a casting method. Specifically, the polyamic acid solution that is a polyimide precursor solution containing the catalyst according to the present invention is continuously cast on the metal belt. In this connection, it is preferable that the polyimide precursor solution be cast on the metal belt to a thickness of 5 to 500 μm. Subsequently, the cast film is heated at 50 to 140° C. for 2 to 60 min to form self-support solid film having a volatile component content of 10 to 30 wt %. Both ends of the self-support solid film are fixed to a plurality of film grips that are provided on a pair of chains capable of moving along rails, and the solid film is then provided to a continuous heating furnace. The solid film may be heated in the furnace at 150 to 230° C. for 10 to 120 min to perform the imidization reaction, so that a polyimide film having a volatile component content of less than 1 wt % is formed in a thickness of 1 to 100 μm. However, the scope of the present invention is not limited to the above-mentioned process, but a process known in the related art may be used to produce the metal laminate plate.

Furthermore, the present invention provides a coverlay film of a metal laminate plate containing polyimide.

The coverlay film of the metal laminate plate may be manufactured using the same method as a typical manufacturing method of a coverlay film which is known in the related art, except that polyimide of the present invention is used.

Polyimide which is prepared according to the present invention has excellent processibility due to the curing at low temperatures, and may be used as an insulating film of a metal laminate plate or a coverlay film for print substrates or hard disks.

### MODE FOR THE INVENTION

A better understanding of the present invention may be obtained in light of the following Examples which are set forth to illustrate, but are not to be construed to limit the present invention.

### EXAMPLE

### Production of the Polyimide Film

### Example 1

The solution containing 47.6 g of 4,4′-ODA (4,4′-oxydianiline), which was dissolved in 400 g of N,N-dimethylacetamide (DMAc), was agitated, and 52.4 g of PMDA (pyromellitic dianhydride) was added thereto. The solution was maintained at 5° C. After the agitation for 24 hours, 5 g of triethylamine was added as the catalyst and the additional agitation was performed for 12 hours.

The polyamic acid solution was continuously cast on the metal belt to obtain the solution film having a thickness of 250 μm. Subsequently, the cast film was heated at 80° C. for 10 min to obtain the self-support solid film having a volatile component content of 30 wt %. Next, both ends of the self-support solid film were fixed to a plurality of film grips that were provided on a pair of chains capable of moving along rails, and the solid film was then provided to a continuous heating furnace. The solid film was heated in the furnace at 180° C. for 60 min to perform the imidization reaction, so that the polyimide film was formed to a thickness of 25 μm.

### Example 2

The polyimide film was produced using the same procedure as Example 1, except that triphenylphosphine was used as the catalyst.

### Example 3

The polyimide film was produced using the same procedure as Example 1, except that 1,2,4-triazole was used as the catalyst.

### Example 4

The polyimide film was produced using the same procedure as Example 1, except that 1,8-diazabicyclo[5,4,0]-undecene was used as the catalyst.

### Example 5

The polyimide film was produced using the same procedure as Example 1, except that 2.5 g of 1,8-diazabicyclo[5,4,0]-undecene and 2.5 g of N,N,N′,N′-tetramethylethylene diamine were used as the catalyst.

### Example 6

The solution containing 26.9 g of p-PDA (p-phenylenediamine), which was dissolved in 400 g of N,N-dimethylacetamide (DMAc), was agitated, and 73.1 g of BPDA (3,3′,4,4′-biphenyltetracarboxylic dianhydride) was added thereto. The solution was maintained at 5° C. After the agitation for 24 hours, 5 g of tributylamine was added as the catalyst and the additional agitation was performed for 12 hours. The subsequent process was performed using the same procedure as Example 1 to produce the polyimide film.

### COMPARATIVE EXAMPLE

### Production of the Polyimide Film

### Comparative Example 1

The polyimide film was produced using the same procedure as Example 1, except that the catalyst was not added.

### Comparative Example 2

The polyimide film was produced using the same procedure as Example 1, except that the catalyst was not added and heating was performed at 350° C. for 60 min.

### Comparative Example 3

The polyimide film was produced using the same procedure as Example 6, except that the catalyst was not added.

### Comparative Example 4

The polyimide film was produced using the same procedure as Example 6, except that the catalyst was not added and heating was performed at 350° C. for 60 min.

### EXPERIMENTAL EXAMPLE

### Measurement of Physical Properties of the Polyimide Film

### Experimental Example 1

### Elongation

The elongations of the polyimide films of Examples 1 to 6 and Comparative Examples 1 to 4 according to the present invention were measured using a ASTM D882 91 measurement method, and the results are described in Table 1.

### Experimental Example 2

### MIT Folding Endurance

The MIT folding endurances of the polyimide films of Examples 1 to 6 and Comparative Examples 1 to 4 according to the present invention were measured using a ASTM D2176 89 measurement method, and the results are described in Table 1.

### Experimental Example 3

### Heat Resistance (Solder Float)

The heat resistances of the polyimide films of Examples 1 to 6 and Comparative Examples 1 to 4 according to the present invention were measured using an IPC TM 650 method 2.4.13A measurement method, and the results are described in Table 1.

### Experimental Example 4

### Dielectric Constant

The dielectric constants of the polyimide films of Examples 1 to 6 and Comparative Examples 1 to 4 according to the present invention were measured using an ASTM D150 measurement method, and the results are described in Table 1.

TABLE 1

| | | MIT Folding | | |
|---|---|---|---|---|
| | | Endurance | | |
| | | (number of | Heat resistance | Dielectric |
| | Elongation (%) | folding) | (Solder Float) | constant |
| Example 1 | 45 | 21,000 | Pass | 3.4 |
| Example 2 | 46 | 21,000 | Pass | 3.4 |
| Example 3 | 43 | 21,000 | Pass | 3.4 |
| Example 4 | 47 | 21,000 | Pass | 3.4 |
| Example 5 | 45 | 21,000 | Pass | 3.4 |
| Example 6 | 25 | 10,000 | Pass | 3.3 |
| Comparative | 8 | 5,000 | Fail | 3.6 |
| Example 1 | | | | |
| Comparative | 47 | 22,000 | Pass | 3.4 |
| Example 2 | | | | |
| Comparative | 7 | 1,200 | Fail | 3.4 |
| Example 3 | | | | |
| Comparative | 26 | 13,000 | Pass | 3.3 |
| Example 4 | | | | |

As seen from the results described in Table 1, polyimide of the present invention has desirable strength at low temperatures and excellent physical properties which are capable of being obtained during the curing at high temperatures. Thus, production efficiency is improved and heat resistance and processibility are excellent. Therefore, polyimide of the present invention is easily used to form insulating films of metal laminate plates or coverlay films for print substrates or hard disks.

1. A method for preparing polyimide, comprising:
a) preparing a polyamic acid solution using dianhydride, diamine, and a solvent;
b) adding a catalyst to the polyamic acid solution;
c) applying the polyamic acid solution containing the catalyst; and
d) drying and curing the applied polyamic acid solution to perform imidization.

2. The method for preparing polyimide according to claim 1, wherein the dianhydride is represented by Formula 1: 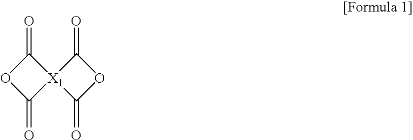
wherein X₁ is one or more selected from the group consisting of 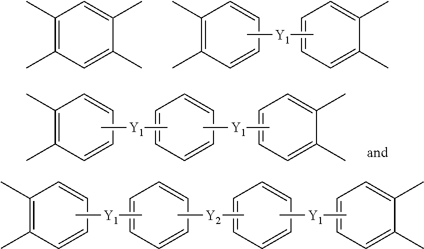
Y₁ and Y₂ are each independently or simultaneously selected from the group consisting of a direct bond, —O—, —CO—, —S—, —SO₂—, —C(CH₃)₂—, —CONH, —(CH₂)n₁-, —O(CH₂)n₂O—, —COO(CH₂)n₃OCO—, and halogen, and
n₁, n₂, and n₃ are each independently an integer in the range of 1 to 5.

3. The method for preparing polyimide according to claim 1, wherein the dianhydride is one or more selected from the group consisting of PMDA (pyromellitic dianhydride), BPDA (3,3′,4,4′-biphenyltetracarboxylic dianhydride), BTDA (3,3′,4,4′-benzophenonetetracarboxylic dianhydride), ODPA (4,4′-oxydiphthalic anhydride), BPADA (4,4′-(4,4′-isopropylbiphenoxy)biphthalic anhydride), 6FDA (2,2′-bis-(3,4-dicarboxylphenyl)hexafluoropropane dianhydride), and TMEG (ethyleneglycolbis(anhydro-trimellitate)).

4. The method for preparing polyimide according to claim 1, wherein the diamine is represented by Formula 2:
H₂N—X₂—NH₂ [Formula 2]
wherein, X₂ is one or more selected from the group consisting of 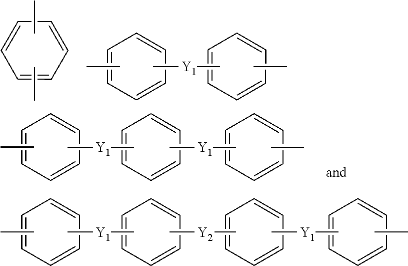
Y₁ and Y₂ are each independently or simultaneously selected from the group consisting of a direct bond, —O—, —CO—, —S—, —SO₂—, —C(CH₃)₂—, —CONH, —(CH₂)n₁-, —O(CH₂)n₂O—, —COO(CH₂)n₃OCO—, and halogen, and
n₁, n₂, and n₃ are each independently an integer in the range of 1 to 5.

5. The method for preparing polyimide according to claim 1, wherein the diamine is one or more selected from the group consisting of p-PDA (p-phenylenediamine), m-PDA (m-phenylenediamine), 4,4′-ODA (4,4′-oxydianiline), 3,4′-ODA (oxydianiline), BAPP (2,2-bis(4-[4-aminophenoxy]-phenyl)propane), TPE-R (1,3-bis(4-aminophenoxy)benzene), and m-BAPS (2,2-bis(4-[3-aminophenoxy]phenyl)sulfone).

6. The method for preparing polyimide according to claim 1, wherein the solvent is one or more selected from the group consisting of N-methylpyrrolidinone (NMP), N,N-dimethylacetamide (DMAc), tetrahydrofuran (THF), N,N-dimethylformamide (DMF), dimethylsulfoxide (DMSO), cyclohexane, acetonitrile, and a mixture thereof.

7. The method for preparing polyimide according to claim 1, wherein an amount of the polyamic acid is 10 to 30 wt % based on a total weight of the polyamic acid solution.

8. The method for preparing polyimide according to claim 1, wherein the polyamic acid solution contains one or more selected from the group consisting of the dianhydride, a diamine defoaming agent, a gel inhibiting agent, and a curing promoting agent.

9. The method for preparing polyimide according to claim 1, wherein an amount of the catalyst is 0.1 to 20 wt % based on a total weight of polyamic acid solids.

10. The method for preparing polyimide according to claim 1, wherein the catalyst is one or more selected from the group consisting of tertiary amine, secondary amine, azole, phosphine, and malononitrile.

11. The method for preparing polyimide according to claim 1, wherein the catalyst is one or more selected from the group consisting of 1,4-diazabicyclo[2,2,2]octane, 2,6-dimethylpiperidine, triethylamine, N,N,N,N′-tetramethylethylenediamine, triphenylphosphine, 4-dimethylaminopyridine, tripropylamine, tributylamine, trioctylamine, N,N-dimethylbenzylamine, 1,2,4-triazole, and triisobutylamine.

12. The method for preparing polyimide according to claim 1, wherein the drying is performed at 50 to 140° C. for 2 to 60 min.

13. The method for preparing polyimide according to claim 1, wherein the curing is performed at 150 to 230° C. for 10 to 120 min.

14. A polyimide prepared using the method according to claim 1.

15. The polyimide according to claim 14, wherein the polyimide is represented by Formula 3: 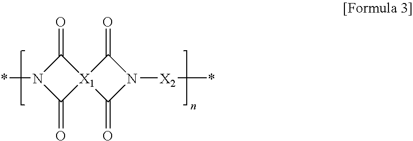
wherein X₁ is one or more selected from the group consisting of 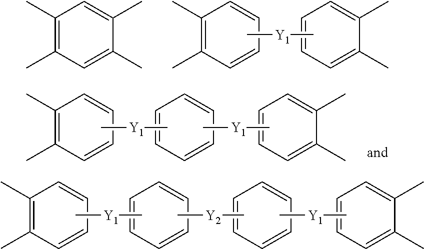
Y₁ and Y₂ are each independently or simultaneously selected from the group consisting of a direct bond, —O—, —CO—, —S—, —SO₂—, —C(CH₃)₂—, —CONH, —(CH₂)n₁-, —O(CH₂)n₂O—, —COO(CH₂)n₃OCO—, and halogen,
n₁, n₂, and n₃ are each independently an integer in the range of 1 to 5,
X₂ is one or more selected from the group consisting of 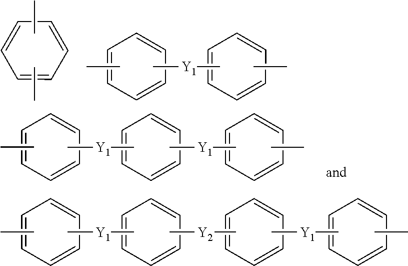
Y₁ and Y₂ are each independently or simultaneously selected from the group consisting of a direct bond, —O—, —CO—, —S—, —SO₂—, —C(CH₃)₂—, —CONH, —(CH₂)n₁-, —O(CH₂)n₂O—, —COO(CH₂)n₃OCO—, and halogen,
n₁, n₂, and n₃ are each independently an integer in the range of 1 to 5.

16. A metal laminate plate comprising the polyimide of claim 15.

17. A coverlay of a metal laminate plate comprising the polyimide of claim 15.
